(19) United States
(12) Patent Application Publication
(10) Pub. No.: US 2011/0039229 A1
(43) Pub. Date: Feb. 17, 2011

(54) COMPUTER AIDED CANAL INSTRUMENTATION SYSTEM AND A UNIQUE ENDODONTIC INSTRUMENT DESIGN

(75) Inventor: Steven S. Senia, Marina Del Rey, CA (US)

Correspondence Address: DISCUS DENTAL, LLC, 8550 HIGUERA STREET, CULVER CITY, CA, 90232, US

(73) Assignee: DISCUS DENTAL, LLC, Culver City, CA (US)

(21) Appl. No.: 12/853,123

(22) Filed: Aug. 9, 2010

Related U.S. Application Data
(60) Provisional application No. 61/233,009, filed on Aug. 11, 2009.

(51) Int. Cl. A61C 1/00

(52) U.S. Cl. 433/131

(57) ABSTRACT

A dental handpiece with an integrated camera and computer. Computer receives information input by dental professionals and data retrieved from integrated sensors. Computer allows pre-programmed procedural steps and information supplied by dental professional to be stored for later use. Computer transmits camera image, stored information and real-time procedural data to dental professional via attached monitor. Computer assists dental professional in handpiece set-up and procedural steps including feedback as treatment proceeds. Based on data received from the user and sensors, the computer dynamically makes adjustments to the procedural steps as well as handpiece mechanical motion, such as, but not limited to, rotational speed, rotational direction, torque, advance feed rate, and withdraw rate.

### FIELD OF THE INVENTION

This invention relates to an endodontic procedure that may be assisted with computer driven technology.

### BACKGROUND OF THE INVENTION

An endodontic procedure, better known as a root canal, is a dental procedure performed when the pulp of a tooth is infected. In an endodontic procedure, the interior of the root canal space is cleaned, shaped and filled. Over the years, several specialized instruments have been developed in the prior art to assist dental professionals with performing such procedures.

Typically, a procedure consists of opening the top of the tooth called the crown with a series of burs and diamond cutting instruments. Once the crown has been accessed, the pulp (or what is left of the pulp) is removed with endodontic instruments, leaving the root canal space empty. This space is then disinfected with chemicals such as bleach. Following disinfection, the canal space is filled with an inert material such as gutta percha and then the crown of the tooth is restored which may involve replacing the natural crown with a crown made of metal or porcelain.

Due to the small space of the root canal itself, instruments, such as files and reamers, generally need to be small in size and made of hard materials to cut the dentin. Thus, endodontic instruments are prone to breaking. As a result, there is always the risk that an endodontic instrument will break in the middle of a procedure leaving an instrument fragment within the patient's tooth.

Typically, endodontic instruments break when the forces from torsion (twisting), as well as bending fatigue are greater than the instrument's ability to withstand such forces. Rotary instruments are particularly vulnerable because of the forces they are subjected to due to their use in a dental handpiece which causes the instruments to be operated at higher speeds and higher torque compared to use in the dentist's hand. Another drawback with current rotary instruments is that they are operated in dental handpieces that are set at a fixed speed, torque and motion (for example, rotating, push/pull, or reciprocating) even when such motions, speeds or torques may not be appropriate at the time of operation.

Applicant presents a novel new system which integrates computers, physics and metallurgy to reduce endodontic instrument breakage, increase the efficiency of the endodontic procedure and improve patient comfort and health during the procedure. Such a system may also decrease costs, which makes an essential dental procedure available to more people.

### BRIEF SUMMARY OF THE INVENTION

This novel new system may be comprised of several components, such as a handpiece, drive and data cable, drive box, bar code scanner, computer and a chair-side monitor. Various embodiments may utilize some but not all of these components. The microprocessor controls all the key variables of the instrument's operation in an endodontic procedure such as speed, torque, advance, withdraw, compression, tension, and advance depth and withdraw. The microprocessor monitors all of the key variables and makes dynamic changes thus reducing human error in the procedure.

Some of the key variables that the computer monitors and the microprocessor controls are: speed, torque, compression and tension. By constantly monitoring those variables and making adjustments, the microprocessor is able to make the proper adjustments to ensure that those forces do not overcome the instrument's ability to withstand those forces. The computer will store data and track instrument usage, estimated life and replacement cycles so that the instrument can be replaced before a breakage occurs. As a result, the lifespan of endodontic instruments used in this system can be optimized. Patient comfort and health is also increased in that the chances that an endodontic instrument will break in the tooth are decreased.

Another benefit from having a computer monitor and limit the key variables which stress endodontic instrument is that the instruments themselves can be made of a less expensive alloy. For example, instead of constructing an endodontic instrument from expensive NiTi, it can be constructed from less expensive stainless steel.

In addition to monitoring the key variables associated with the endodontic procedure, the computer can also monitor the procedure's progress, such as the penetration of the instruments. By monitoring the procedure itself the efficiency of the procedure is increased because the dental professional no longer needs to use depth rings to know how deep into the canal the instrument is at any given moment.

Also disclosed is an endodontic instrument for use with the handpiece. This endodontic instrument will have a means of identifying it to the computer such that the computer can ensure that the correct endodontic instrument is being used for the application and that the use of the endodontic instrument is within the longevity parameters.

This endodontic instrument will be formed by a hollow cannula. One end of the cannula will be a series of serrations for cutting into the various parts of the tooth being operated on. The other end will be attached to the handpiece.

This endodontic instrument is further designed to be used with a guide wire. The guide wire comprises at least a removable handle, wire and a formation at the end. The handle is used by the dental professional to place the formation within the tooth being operated on. The formation will be larger than the diameter of the hollow cannula of the endodontic instrument. The dental professional then threads the wire into the hollow cannula of the endodontic instrument.

The endodontic instrument will then follow the path created by the wire as it cuts through the tooth. Since formation at the end of the guide wire is larger than the diameter of the hollow cannula, it will ensure that the dental professional does not drill too deep in the tooth. Another benefit of having the formation be of a larger diameter than the hollow cannula is that it also provides a means for easily removing any broken parts if the endodontic instrument breaks by simply removing the guide wire from the tooth.

The present invention together with the above and other advantages may best be understood from the following detailed description of embodiments of the invention illustrated in the drawings.

### BRIEF DESCRIPTION OF THE DRAWINGS

FIG. 1. is a block diagram of the system.

FIG. 2. is an elevated view of the handpiece.

FIG. 3. is an elevated view of an alternate embodiment of the handpiece with the endodontic tool attached.

FIG. 4 shows a cross section of the handpiece.

FIG. 5 shows a cross section of the drive box.

FIG. 6 shows a cross section of the drive and data cable.

FIG. 7 is an elevated view of an endodontic instrument.

FIG. 8 is a view of the proximal end of the endodontic instrument.

FIG. 9 is a view of the distal end of the endodontic instrument.

FIG. 10 is a detail view of the proximal end of the endodontic instrument.

FIG. 10a is a cross section of the proximal end of an alternative embodiment of the endodontic instrument.

FIG. 10b is a cross section of the proximal end of an alternative embodiment of the endodontic instrument.

FIG. 11 is an elevated view of the guide wire.

FIG. 12 is a cross section of a root canal with the guide wire and endodontic instrument.

FIG. 13 is a block diagram of an example endodontic procedure using this system.

FIG. 14 is a screenshot of the phase selection screen.

FIG. 15 is a cross section view of the tip

FIG. 16 is a elevated view of an endodontic instrument

FIG. 17 is a block diagram of a networked group of systems.

### DETAILED DESCRIPTION OF THE INVENTION

Endodontic instruments separate when forces from torsion (twisting) and bending fatigue overcome the instrument's ability to withstand such forces. Comparatively, instruments fare much better when subjected to tension (pulling) and compression (pushing) forces. Endodontic instruments also separate from misuse. They can be pushed too hard and pushed too fast. They can be over used or used at the wrong speed and torque. Canal instrumentation, or the cleaning and shaping for filling of a root canal, is fraught with problems such as instrumenting long or short, under or over enlarging the canal, ledging, zipping, perforating; most of which are caused by human error. This system controls these variables, eliminating human error, by applying an in-depth understanding of physics and metallurgy with computer aided technology.

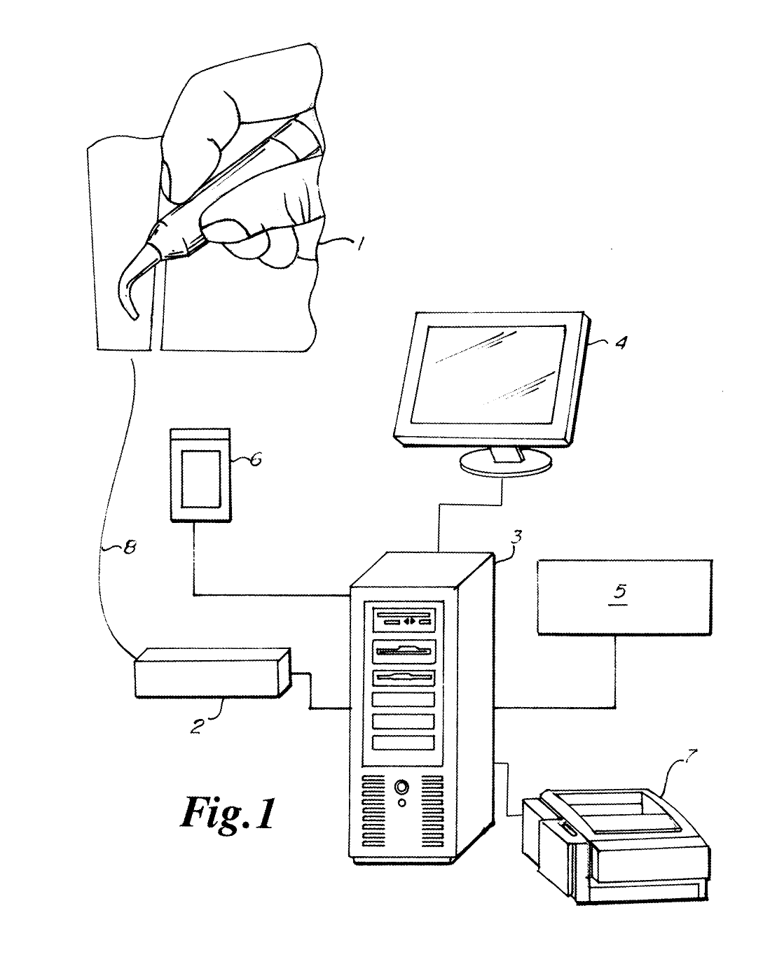

FIG. 1 shows a system 17 for performing endodontic procedures. The key devices which comprise the system 17: a handpiece 1, drive and data cable 8, drive box 2, computer 3, chair-side monitor 4, input system 5, scanner 6 and printer 7. The input system 5 can be any number of commonly known input systems 5, such as, but not limited to a keyboard, mouse or trackball. Input system 5 can also be integrated with chair-side monitor 4 as a touch screen. In an alternative embodiment, the scanner 6 can be integrated onto the handpiece 1 instead of having it as a separate device. System 17 is in essence a computer 3 with a chair-side monitor 4 used to control a handpiece 1. Prior art handpieces are set at a fixed speed, torque and motion (rotary, reciprocating, rapid push-pull), advance and withdrawal must be controlled manually by the dentist. Whereas, this system 17 can perform all of these motions and advance/withdraw while and alternative embodiment will dynamically varying the speed, torque, advance, withdrawal, compressive and tensile forces as needed to maintain safe and effective operation.

The handpiece 1 that is intended to be used with this system 17 is different than handpieces that currently exist in the prior art because the key mechanical components have been relocated from the handpiece 1 to the drive box 2. In other words, this handpiece 1 does not contain the same moving parts of prior art handpieces, such as the rotary motor. This allows the much greater flexibility in selecting motors and other components because they no longer have to be placed inside the handpiece 1 held by the dentist. This also results in a lighter handpiece 1 which is more comfortable for the dental professional to operate. Also, by relocating the moving parts such as the motors and drive gears to the drive box 2, space is left to add helpful features such as a light and camera. Power is supplied to the handpiece 1 by the drive and data cable 8. In another embodiment, the handpiece 1 powered by a separate power cable or by an internal power source, such as a battery.

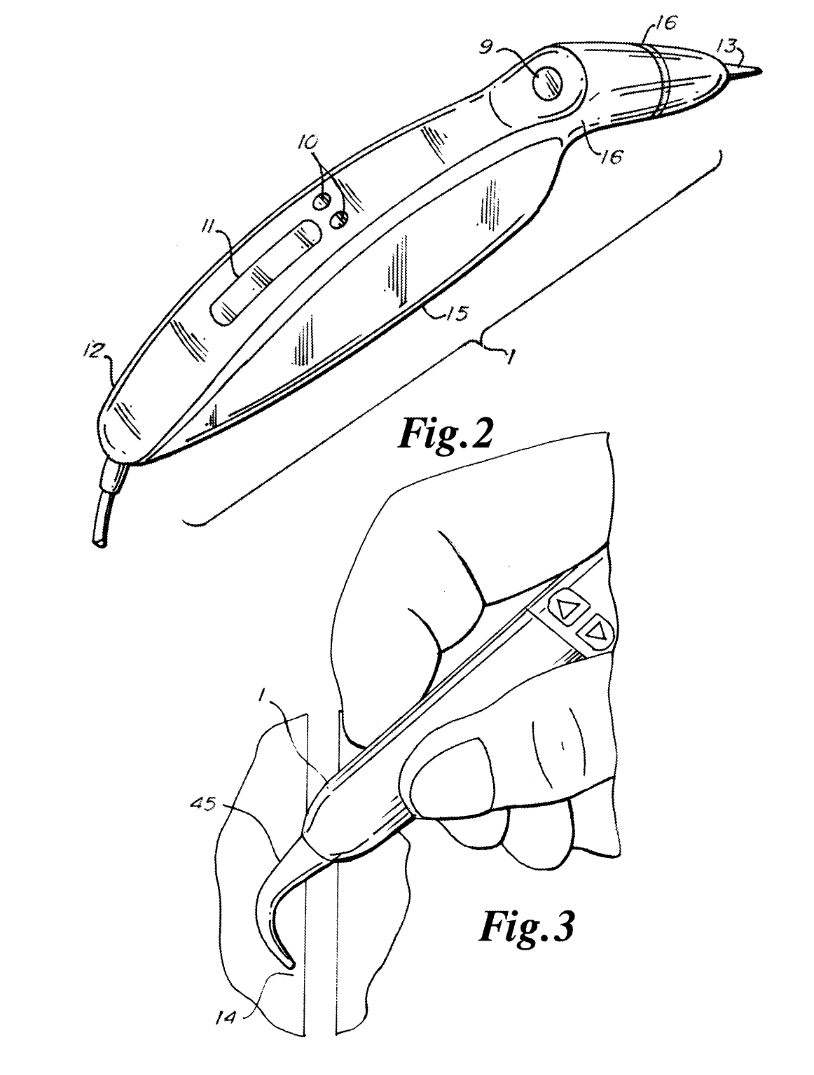

FIG. 2 is a view of the external features of the handpiece 1. The handpiece 1 is comprised of external housing 15. External housing 15 can be shaped in any number of ways that is ergonomically comfortable for the dental professional to handle with one hand. Push button 9 on the housing activates and/or deactivates the handpiece 1. Additional push buttons 10 controls other features of the handpiece 1, for example, a light, camera 46 and integrated scanner 6. LCD 11 display on the handpiece 1 displays information related to the operation of handpiece 1. At the distal end 16 of the handpiece 1, the drive and data cable 8 extends to the drive box 2. At proximal end 12 of the handpiece 1, there is an attachment mechanism 13 of the endodontic instrument 14. FIG. 3 shows an alternative embodiment of the handpiece 1 with the endodontic instrument 14 attached.

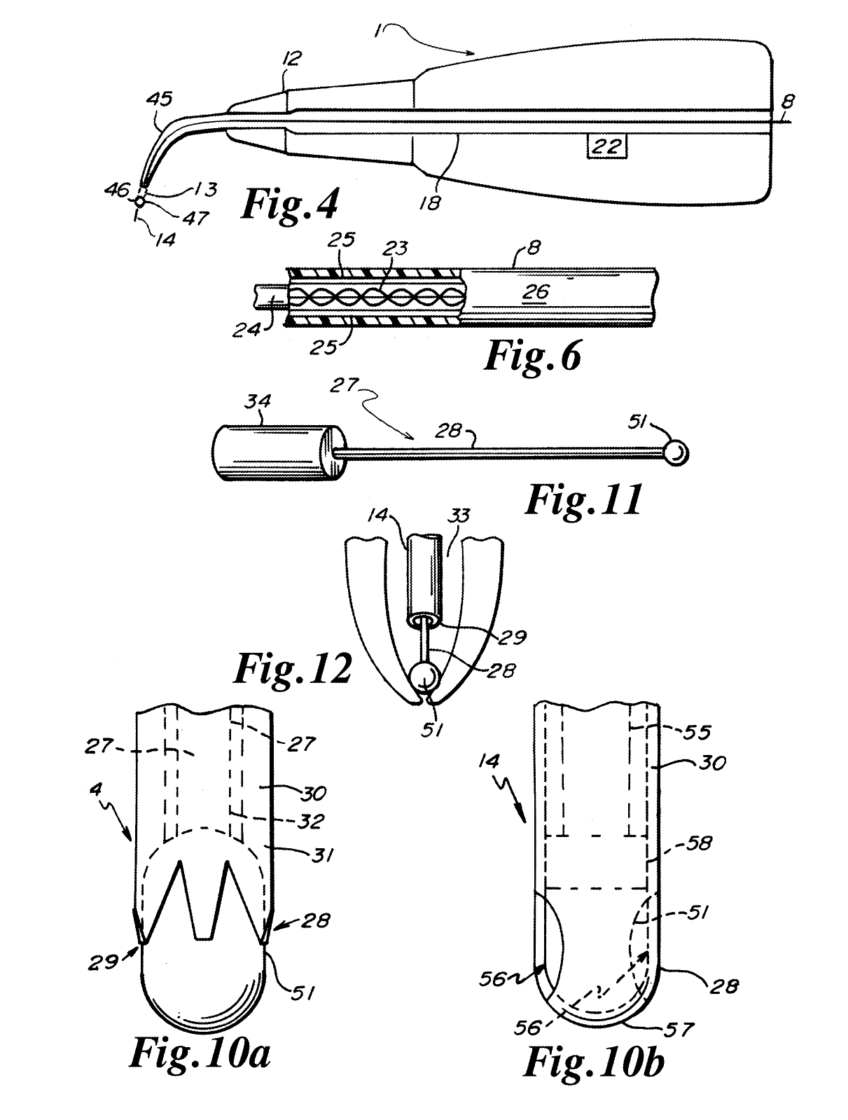

Taking the place of the gears and motors and other moving parts in handpiece 1 is drive and data cable 8. FIG. 4 shows that within handpiece 1 is a hollow bore 18. The drive and data cable 8 is located within the hollow bore 18 of the handpiece 1 and runs the length of the handpiece 1. Mounted within the handpiece 1 are sensors and load cells 22 which transmits information to the drive box 2 through the drive and data cable 8. The proximal end of drive and data cable 8 has attachment mechanism 13 of the endodontic instrument 14. Tip 45 is bent so that the endodontic tool 14 has easy access to the patient's teeth. However tip 45 cannot be bent at such an angle so that drive and data cable 8 cannot freely rotate. In an alternative embodiment, the proximal end 12 will have means to pivot and rotate such that the dental professional can set the angle of the tip 45 to their own individual preference.

The attachment mechanism 13 will allow the dental professional to quickly connect and disconnect an instrument easily. Examples of such attachment mechanism 13 will be swing latch, spring latch, push button chuck or it could be held in place with a magnetic force that would be engaged and disengaged electronically. The drive and data cable 8 can also provide power to other components helpful to the dentist like a light 47 and camera 46, as depicted in FIG. 15, which replace the need for dentists to use expensive magnification such as microscopes and magnifying loupes. In an alternative embodiment, the drive and data cable 8 can provide power to a scanner 6 integrated into the handpiece 1. In an alternative embodiment, the proximal end 12 of the handpiece 1 can be bent for easier access to posterior teeth. In another embodiment, the proximal end 12 of the handpiece 1 can have the means to rotate and/or tilt. In yet another embodiment, the handpiece 1 contains a mechanism, such as an attachment for a rubber dam clamp, for locating and fixturing the handpiece 1 on top of the tooth. In yet another embodiment, the handpiece 1 can have a sheath made of a material suitable for autoclaving. Such material can include, but is not limited to, plastic, thin gauge aluminum, and other materials that can be molded and shaped into an ergonomically comfortable handpiece 1.

FIG. 15 is a cross section of the tip 45. As discussed above, hollow bore 18 runs the length of handpiece 2. Hollow bore 18 goes all the way to the end of the tip 45. Drive and data cable 8 runs the length of hollow bore 18, through tip 45 and ends at attachment mechanism 13. Endodontic instrument 14 is attached at attachment mechanism 13. Other embodiments will have a camera 46 and/or light source 47 at the end of tip 45.

At the distal end of the drive and data cable 8 is the drive box 2. FIG. 5 shows that the drive box 2 contains a plurality of motors 19 which are connected to the drive and data cable 8. The motors 19 with attached encoders 20 are driven by at least one microprocessor 21 work together to execute a series of preprogrammed motions. Inside the drive box 2 at least one motor 19 spins the drive and data cable 8 clockwise or counterclockwise, while another motor 19 advances or withdraws the drive and data cable 8 in and out along a linear slide. Power supply 46 provides power within the drive box 2.

A plurality of sensors and load cells 22 mounted within handpiece 1 and drive box 2 monitor torque, tension and compression forces and through a feedback loop. This information is supplied to the microprocessor 21 which in turn relays the information to computer 3 for processing. If any adjustments are necessary, computer 3 then sends information to the microprocessor 21 in drive box 2, which then signals motors 19 to keep these stresses within the endodontic instrument's 4 failure levels stored in the computer 3 to prevent endodontic instrument 14 failure. For example, when the instrument is engaging dentin in a clockwise forward rotation, the sensors and load cells 22 are able to provide the information needed by the 21 microprocessor to know when preset compression and torque levels are reached. Microprocessors 21 then signals the 19 motor to stop forward rotation before the instrument is allowed to buckle or fail in torsion. When the instrument is fully engaged with dentin and begins to pull out of the canal, the sensors and load cells 22 are able to provide the microprocessors 21 with the information it needs to know when a preset tension level is reached. The microprocessor 21 then signals the motors 19 in the drive box 2 to reverse rotation so that the instrument can unthread itself rather than pulling itself apart.

Data is communicated from the sensors and load cells 22 in the handpiece 1 to the microprocessors 21 through the drive and data cable 8. FIG. 6 shows the various components comprising the drive and data cable 8. The components would include at least: a plurality of drive wires 23, inside protective sheathing 24, a plurality of data cables 25, wires to transmit power to and from the handpiece 1 and drive box 2 and outside protective sheathing 26. The innermost layer consists of the drive wires 23 which rotate and advance/withdraw the instrument. The drive wires 23 are comprised of many individual strands of wires wound together in the form of a strong but flexible cable, much like an automobile speedometer cable. The drive wires are coupled to the motors 19 in drive box 2 where its directional motions (advance/withdrawal, clockwise/counterclockwise) and rotational speed are controlled by the motors 19. The next layer is the inside protective sheathing 24 which separates the drive wires 23 from the data cables 25. There is sufficient space between the inside protective sheathing 24 and drive wires 23 such that drive wires 23 can spin freely within it. The inside protective sheathing 24 should be made of a material flexible enough to bend, but rigid enough to ensure that drive wires 23 can freely spin. The data cables 25 are made of wires which provide power from the powers supply 46 and I/O data between the handpiece 1, drive box 2 and microprocessors 21 so that an on/off switch, light 47, camera 46 and other useful tools can be located conveniently in the dental professional's hand. The outermost layer 26 is sheathing that holds the assembly of layers together so that the drive wires 23 and data cables 25 are not exposed. The outermost layer 26 should be made of a material that is flexible enough to bend.

In the alternative, the drive and data cables can be separate cables. In this embodiment, drive wire 23 would be comprised of many individual strands of wire wound together in a strong but flexible cable. It would then be covered with outermost layer 26. Data cables 25 would be separate from drive wire 23 so that drive wire 23 would be free to rotate. Data cables 25 would be covered with outermost layer 26. Outermost layer 26 should be made of a material flexible enough to bend, but rigid enough to ensure that drive wires 23 can freely spin.

In yet another alternative embodiment, data can be communicated to the microprocessor 21 wirelessly, through any number of wireless data transmission protocols, such as radio frequency, infrared or Bluetooth. In this embodiment, handpiece 1 is equipped with a wireless transmitter and drive box 2 is equipped with a wireless receiver. Similar to the drive and data cable 8, the cable used in this embodiment would have four layers. The innermost layer would be the drive wire 23, which would still be comprised of many individual strands of wire wound together. The drive wire 23 is then covered with the inside protective sheathing 24 to separate it from the power cables. The inside protective sheathing 24 should be made of a material flexible enough to bend, but rigid enough to define a hollow space with a diameter large enough to ensure that drive wires 23 can freely spin. Then there is an outmost sheath 26 to cover the power cables.

Attached to the handpiece 1 will be an endodontic instrument 14. FIG. 16 is an example endodontic instrument 52. Current endodontic instruments are typically made with either a latch type handle 48 for engine driven use or a handle 48 designed to be used in the dental professional's hand. Attached to the handle 48 is a shaft 49 which ends in the working blades 50.

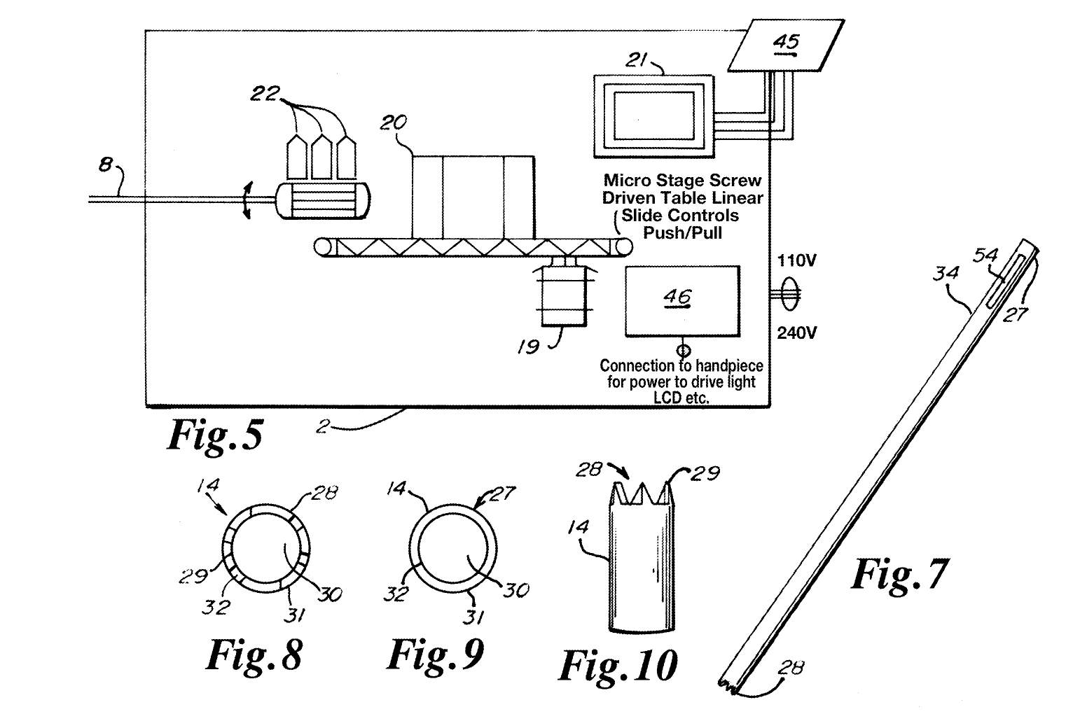

FIG. 7 shows another endodontic instrument 14 used with handpiece 1 will have a handle 34 for attachment to the attachment mechanism 13. The handle 34 will also have a means for information coding 54 which will allow information about the instrument's design to be embedded electronically—including information that will uniquely identifying the specific instrument. Information kept about the instrument might include its material type (stainless steel, nickel-titanium), what motions it is capable of (i.e., rotating, reciprocating, push/pull), speed range, maximum torque, useful life, a unique serial number, when it was first used, etc. The means for information coding 54 can be a bar code, alphanumeric code, RFID, authentication chip or similar type technology can be used to store and supply this information to the computer 3 when needed.

The endodontic instrument 14 shown in FIG. 7 has a proximal end 27 and a distal end 28. FIG. 10 shows the distal end 28 of the endodontic instrument in detail. The distal end 28 of endodontic instrument 14 contains a plurality of serrations 29. FIGS. 8 and 9 shows that the endodontic instrument 14 has a hollow cannula 30. The endodontic instrument 14 provides excellent cutting efficiency over prior art endodontic instruments because the cut debris which contains harmful bacteria is funneled inside the hollow cannula 30 and therefore is removed from the canal with the endodontic instrument 14. The hollow cannula 30 has both an inner diameter 32 and an outer diameter 31.

The proximal end of endodontic instrument 14 is connected to the handpiece 1 by attachment mechanism 13. The shape of the serrations 29 can be by any number of different configurations by any number of different manufacturing means known to those skilled in the art, such as laser cutting, grinding, etc. The instrument can be made of any number of biocompatible metals or metal alloys capable of being autoclaved. Nickel titanium alloy or stainless steel are excellent choices due to their combination of biocompatibility, flexibility, durability and cost.

FIG. 8 is a view of the distal 28 end of the endodontic instrument 14. FIG. 9 is a view of the proximal end 27 of the endodontic instrument. In both FIGS. 8 and 9, the outside diameter 31 of the endodontic instrument 14 will typically range from 0.10 mm to 2.0 mm. The inside diameter 32 will typically be from 50 to 90% of the outside diameter. The proper outside diameter 31 and inside diameter 32 balance is needed to maintain the appropriate amount of wall thickness strength and bending flexibility for the instrument to remain effective. Instrument lengths will typically range from 16 mm to 50 mm.

The endodontic instrument 14 as shown in FIGS. 7-10 is intended to be used concurrently with guide wire 27. FIG. 11 shows the guide wire 27 that is used concurrently with endodontic instrument 14. Guide wire 27 is comprised of wire 55. At the distal end of wire 55 is a formation 51 and a handle 34 at the proximal end. Wire 55 can be made of any number of biocompatible metals or metal alloys capable of being autoclaved. Nickel titanium alloy or stainless steel are excellent choices due to their combination of biocompatibility, weight, durability, tensile strength and cost. The guide wire 27 should be made in various lengths between 21 mm to 50 mm. The width of the formation 51 at the distal end of the guide wire 27 will typically be from 0.10 mm to 1.00 mm and the attached wire 55 will always be slightly smaller from 0.08 mm to 1.90 mm. The wire 55 will typically be made from nickel-titanium but can be made of any material with significant tensile strength so that it can be pulled from the canal without concern of it breaking apart.

At distal end of the guide wire 27 contains a formation 51 larger than the inside diameter 32 of the hollow cannula 30 of the endodontic instrument 14. The formation 51 can be any number of shapes, but the preferred shapes would be a ball, sphere, teardrop or ellipse. Those shapes are preferred because of the absence of sharp edges which can damage the delicate canal walls and formation 51 is intended not to have a cutting characteristic. Removably coupled to the proximal end of the guide wire 27 is a handle 34. The handle 34 is removably coupled to the wire 55. The handle 34 will have an opening which the wire 55 will go into. The opening 28 will provide a loose fit for wire 55 such that the handle 25 will stay in place when pushing the guide wire 27 down, but comes off when pulling the handle up. The formation 51 and the wire 55 should be made from one piece of material to ensure maximum adhesion strength so that guide wire 27 can be pulled without concern of it breaking apart.

FIG. 10a shows yet another embodiment of endodontic instrument 14. In this embodiment, the endodontic instrument 14 and guide wire 27 are not separate components. Rather, guide wire 27 is integrated into the endodontic instrument 14. In this embodiment, formation 51 is attached to the distal end 28 of the endodontic instrument 14. The formation 51 is attached to the distal end of endodontic instrument 14 by any number of methods known to those skilled in the art, such as by adhesive or laser welding. The formation 51 can be of any shape, but the preferred shape is that of a ball, sphere, teardrop, ellipse or other shape which does not have sharp edges because formation 51 is not intended to have a cutting characteristic.

Distal end 28 of the endodontic instrument 14 has a plurality of serrations 29. The serrations can be formed by any number of methods known to those skilled in the art, such as by grinding or laser cutting. Formation 51 is larger than the inner diameter 32 of the hollow cannula 30, but smaller than the outer diameter 31 of the hollow cannula 30, so that the serrations 29 can still cut. Wire 27 is still connected to formation 51 and the diameter of wire 27 is smaller than that of the inner diameter 32 of the hollow cannula 30. Wire 27 is positioned within hollow cannula 30 and travels parallel to hollow cannula 30. To maximize adhesion strength when wire 27 is pulled, formation 51 and wire 27 should be made from one piece.

FIG. 10b shows yet another embodiment of endodontic instrument 14. In this embodiment, the distal end 28 has a rounded tip 57. Wire 27 has a diameter smaller than the inside diameter 32 of the hollow cannula 30. Formation 51 is attached to wire 27 and shaped to fit within the rounded tip 57 of the distal end 28. Wire 27 is fixtured to the wall of the hollow cannula 30 by an adhesive 58. A plurality of cutting blades 56 are then formed by cutting out portions of the hollow cannula 30 in the approximate region of the rounded tip 57 where the formation 51 is located.

FIG. 12 shows a root canal 33 with the guide wire 27 inserted and endodontic instrument 14 within the root canal 33. The handle 34 is used to make it easier for the dental professional to guide and push the guide wire 27 such that the formation 51 contacts the end of the root canal 33. Once reaching the desired depth, the handle 34 is removed from the guide wire 27. FIG. 15 shows a cross section of tip 45 with endodontic tool 14 attached and wire 55 inserted into endodontic tool 14. Wire 55 will be shorter then the length of endodontic tool 14.

Each endodontic instrument 14 capable of being connected to the handpiece 1 is designed for a specific purpose. The endodontic instrument 14 must properly prepare the root canal 33 while not causing ledges or break such that the fragment cannot be removed from the root canal 33. Each endodontic instrument 14 will be designed to accomplish its unique Cutting Objective as efficiently and safely as possible.

With the formation 51 of a larger size than the diameter of the hollow cannula 30, the endodontic instrument 14 cannot be pushed past the end of the guide wire 27, thereby effectively controlling the length which the endodontic instrument 14 is allowed to travel in the root canal 33. As a result the dental professional no longer needs to be concerned that the endodontic instrument 14 would travel too long and go out the end of root canal 33. In addition, the guide wire 27 can be pulled from the canal and bring with it any broken fragment in the situation where 14 cutting instrument breaks while in the canal. Thus, the dental professional no longer needs to be concerned about leaving broken fragments in the root canal 33 in the even the endodontic tool 14 breaks within the root canal 33.

The use of the guide wire 27 provides several advantages and is a key part of the system 17 because without it the endodontic instrument 14 is not likely to be flexible enough the follow the true path of the root canal 33 and will thus form a ledge effectively preventing subsequent instruments from getting down to the end of the root canal 33. Because the formation 51 at the end of the guide wire 27 is larger than the hollow cannula 30 of the endodontic instrument, if the instrument happens to break while inside the root canal 33, the broken parts can be retrieved by pulling the guide wire 27 out of the root canal 33. Another benefit of having a formation 51 that is larger than the hollow cannula 30 of the endodontic instrument 14 is that the formation 51 also prevent the endodontic instrument 14 from pushing past the end of the guide wire 27, so the chances that the endodontic instrument 14 will perforate out the end of the root canal 33 are greatly diminished. As a result, the use of the endodontic instrument 14 in conjunction with the guide wire 27 ensures that the proper working length is always drilled. A rubber endo stop would be placed onto the shaft of the guide wire 27 so that the clinician will know when it has reached the end of root canal 33. An alternative embodiment would have length ring markings on the wire 27 in place of endo stops for the same purpose. The gap between the guide wire 27 and hollow cannula 30 of the endodontic instrument also provides an advantage in that debris that results from the drilling will accumulate inside the hollow cannula 30 instead of the root canal 33.

Also provided is a method of using the endodontic instrument 14 together with the guide wire 27. First, the working length is determined with an endodontic file, such as a K-File #15. Then another endodontic file, such as a K-File #20, is used to instrument down to the working length until it feels loose. Next, the dental professional selects a guide wire 27 size which is able to traverse the working length in the root canal 33, but cannot go past the working length. The dental professional inserts the guide wire 27 into the root canal 33 that has been drilled until the formation 51 reaches the end of the working length. Once the guide wire 27 is in place, the handle 34 is removed. Following the guide wire 27 placement, the dental professional selects the appropriate size of the endodontic instrument 14. Most of those skilled in the art will use an estimated Final Apical Size chart, such as those supplied by Discus Dental, LLC, to determine the appropriate endodontic instrument 14 size. The endodontic instrument 14 is then placed over the guide wire 27, such that the wire 55 goes through the hollow cannula 30 of the endodontic instrument 14. Once the endodontic instrument 14 is correctly placed over the guide wire 27, cutting commences. Depending on the progress of the cutting, the dental professional can increase or decrease the size of the endodontic instrument 14. If the endodontic instrument 14 happens to break within the root canal 33, the broken parts can be easily removed by removing the guide wire 27. Because the formation 51 at the end of the guide wire 27 is larger than that of the hollow cannula 30 of the endodontic instrument 14, the broken parts will be contained by the guide wire 27 so that it can be removed with the removal of the guide wire 27. Once the end of the working length is reached, the dental professional is able to remove both the endodontic instrument 14 and guide wire 27 from the root canal 33. After removing the endodontic instrument 14 from the root canal 33, the debris that has collected within the hollow cannula 30 of the endodontic instrument 14 is flushed out of the endodontic instrument 14 instrument by way of suction or pressure or ultrasonic cleaning of the hollow cannula 30 of the endodontic instrument 14.

An alternate method utilizing the endodontic tool 14 shown in FIG. 10a is similar. However, since the wire 27 and formation 51 are integrated within the endodontic instrument 14, the dental professional no longer needs to place the endodontic tool 14 over the wire 27. Instead, since formation 51 is non-cutting, it guides the serrations 29 and the rest of the endodontic tool 14 by following the shaft in the root canal 33 which has already been formed. If endodontic tool 14 breaks within the root canal 33, the broken parts can be removed by pulling wire 27 out of the root canal 33. Because the formation 51 has a larger diameter than the inside diameter 32 of the hollow cannula 30, the broken endodontic instrument 14 pieces will be collected by the formation 51. The method of using the embodiment of the endodontic tool 14 shown in FIG. 10b is similar. However, if the endodontic tool 15 breaks within root canal 33, since wire 27 is fixtured onto the inside wall of hollow cannula 30, the broken parts of the endodontic tool are removed because the broken endodontic tool 14 parts will gather at the endodontic tool 14 part which is fixtured onto wire 27.

Going back to FIG. 1, drive box 2 transmits and receives data to the computer 3 by I/O connections 45. The I/O connections 45 can be by any number of data transfer means. For example, the I/O connections 45 can be a wired connection connected such as a USB or Firewire cable or through some other standard data cable protocol. In the alternative, the I/O connections 45 can be wireless through any number of standard wireless communication protocols such as infrared, Bluetooth, radio frequency or other standard wireless data transmission protocol.

Communication between the dental professional and the computer 3 occurs through several devices. The input system 5 provides a means for information to be entered into the computer 3 by the dentists/assistant and chair-side monitor 4 also provides information to the dental team. If the input system 5 is a touch screen, then it can be integrated with chair-side monitor 4. A printer 7 can be connected to the computer 3 and can be used to print data stored within the computer 3 such as case information which can be stored in the patient's record as well, procedure data or endodontic instrument 14 information.

The main task of computer 3 is to monitor and store data which is used to control the motion of the endodontic instrument 14 via the microproceessors 21. The computer 3 communicates with the drive box 2 through the I/O connections 45 to the microprocessors 21, which in turn controls the drive and data cable 8 which controls the motion of the endodontic instrument 14 such as turning it clockwise/counterclockwise at a certain rotational speed or advancing/withdrawing at a certain feed rate. Feed rate is the speed at which the endodontic instrument 14 advances through the material. Stored within the computer 3 are preprogrammed guides to the various phases of the procedure and preprogrammed cutting motions which tell the endodontic instrument 14 how it will move once within the root canal 33.

The microprocessers 21 reads data taken form the sensor and load cells 22, such as rotations, torque, tension, compression, and length of advancement and withdrawal and uses data stored in the computer 3 to adjust the motions accordingly. The computer 3 is able to store information for each endodontic instrument 14 attached to it because it can identify each unique endodontic instrument 14 attached to it. Physical data about each instrument type is stored such as: bending moment, torque to failure, torsion to failure; rotations to failure for each endodontic instrument 14. These values will be determined by testing performed on the endodontic instrument 14 prior to commercial use. The computer 3 can differentiate between the various endodontic instruments 14 by any number of information coding 54 means, such as optical recognition, bar code scanning, authentication chips, authentication codes transmitted from the handpiece 1 to the computer 3, and any other means known to those skilled in the art. Also, by identifying the various endodontic instruments 14, the computer 3 is capable of identifying the endodontic instrument 14 inserted into the handpiece 1 so that it can know which motions are appropriate for that particular endodontic instrument 14 type to achieve its Cutting Objective, which is reaching a certain predetermined depth in the tooth.

The computer 3 also monitors and the microprocessors 21 dynamically control all key variables involved in the procedure and makes adjustments as the procedure progresses. Such variable includes speed, torque, and advance, withdraw, compression, tension, torque, advance depth, and withdraw. These key variables are controlled and changed dynamically during instrumentation to optimize performance while virtually eliminating the risk of a mishap caused by human error.

In addition to monitoring and controlling the endodontic instrument 14 and various procedure variables during the instrumentation process, the computer 3 and microprocessors 21 will also monitor the working length and working width to ensure that the canal is prepared accurately to both the correct length and correct width. Depth of penetration is important; care must be taken to end apical advancement at the desired working length as determined by the dental professional. This will eliminate the need for troublesome depth rings and endodontic stops.

The advantage of having a computer 3 monitor the key variables of instrumentation and the progress of the working length and working width is that the handpiece 1 will use inputs of torque and cutting distance to calculate the working width and compare it against working width averages and ranges stored in the computer 3. Based on all of that information, the computer 3 can accurately determine when the correct Final Apical Size, or the largest endodontic instrument 14 taken to the working length, has been reached and the root canal 33 has been prepared properly.

In addition to monitoring the instruments and progress of an endodontic procedure, this system 17 will also assist the dental professional in the actual performance of the procedure. The computer 3 will have stored pre-programmed interactive walkthroughs of the various phases of an endodontic procedure. The computer 3 will ask a question, the dental professional will respond using the input system 5 and the computer 3 will take control until it is ready for the next command.

As the dental professional is going through the steps of the phase, the computer 3 is monitoring the progress of the procedure and makes any necessary adjustments to the variables of the procedure to improve the procedure's efficiency. Throughout the process the computer 3 receives continuous feedback through the sensors and load cells 22 built into the handpiece 1 and drive box 2. These sensors and load cells 22 deliver feedback of key variables which the microprocessors 21 process. The microprocessors 21 then sends signals to the motors 19 that control the advance/withdraw, rotational speed, and direction of the instrument. These variables are changed as needed to optimize cutting efficiency while keeping the instrument within known safety limits stored in the computer 3. The bulk of the manual effort associated with root canal instrumentation is done by the computer 3. This will allow the “average” dentist to do the work of an expert, quickly and efficiently, while eliminating operator fatigue and potential human error.

The instrumentation process continues until the dentist is informed via the chair-side monitor 4 that the phase has been completed and the computer 3 guides the endodontic instrument 14 back to its starting position. The computer 3 also tracks endodontic instrument 14 usage and continually calculates the remaining useful life of the endodontic instrument 14. Computer 3 will inform the dental professional when endodontic instrument 14 is to be replaced so the dental professional can know that they will not overuse the endodontic instrument 14 and risk breakage and yet receives the full benefit of that endodontic instrument 14 before it must be disposed. The computer 3 can also utilize and maintain replacement records of the endodontic instrument 14.

Due to the fact that the computer 3 and microprocessors 21 will take control of the endodontic instrument's 14 motion and that rotation of the endodontic instruments 14 will be avoided (to limit chances of fracture from fatigue) the need to use endodontic instruments 14 made from more expensive alloys (i.e., NiTi) may not be necessary. The endodontic instruments 14 can be made from common designs familiar to dentists, for example, K-Files, and made from common materials (stainless steel). Therefore, the added expense of the endodontic instrument's 14 unique connection device to the handpiece 1 may be offset by lower costs to make the endodontic instruments 14.

The computer 3 is capable of utilizing stored information that will be needed by the programs which control the motion of the endodontic instrument 14. Information such as anatomical data, physical properties of instruments, and case history information will provide the necessary data for calculations like remaining useful life of the instrument, Working Width determination and data for the Patient Case Report. The interactive process dialogs will also be run from the computer 3 and display on the chair-side monitor 4.

For example, the computer 3 will continually track the endodontic instrument's 14 remaining useful life by taking into account the torque and number of cumulative rotations (both forward and reverse) of the endodontic instrument 14. The computer 3 will not only count the number of rotations it will make a calculation adjustment based on rotation speed, torque and bending to be sure the endodontic instrument 14 is changed when reaching a preprogrammed level set with a generous safety factor. When the endodontic instrument 14 has reached its fatigue limit, the handpiece 1 will stop, the endodontic instrument 14 will be automatically withdrawn from the root canal 33 and the dental professional will be prompted to replace the endodontic instrument 14 before beginning again. The computer 3 will not allow that endodontic instrument 14 to be used again. Therefore, the optimal number of uses can be obtained with a given endodontic instrument 14 and yet be well within safe limits.

The user interfaces with the computer 3 through Interactive Process Dialogs. The Interactive Process Dialogs is where the computer 3 prompts the user for input and provide procedure instructions. The Process Dialog will contain a unique set of preprogrammed instrument motions which are executed with the drive box 2 and handpiece 1. These programs control advance/withdraw rates, rotational speed, rotational direction, etc., of the endodontic instrument 14 and are changed by the computer 3 based on the information provided by the user as well as the conditions that the computer 3 is monitoring. As a result, the computer 3 can make dynamic changes to the procedure depending on the situation encountered in real time. For example, an “easy canal” will utilize high rotational speeds, high feed rates, etc., while a difficult canal would require the opposite. The computer 3 analyzes the situation and gives instructions to change the instrument's preprogrammed motion when conditions change (i.e., from easy to difficult or vice versa). The goal is for the endodontic instrument 14 to always operate at the optimal speed so that the operation can be completed in the shortest amount time while always staying within the safety limits of the endodontic instrument 14. In other words, it goes fast when it is safe and slows down when not.

An example of a preprogrammed Cutting Objective would be as follows: Via the 3 monitor, the dentist is prompted to move the handpiece 1 to the starting position and press the push button 9 to activate the handpiece 1. The handpiece 1 takes control, advancing the endodontic instrument 14 into the root canal 33, without rotation, until it feels a programmed level of resistance to forward advancement indicating that it has encountered dentin. The endodontic instrument 14 then withdraws 0.5 mm, begins clockwise rotation at a preset speed and advances at a preset feed rate until it reaches a maximum safe torque level, then stops rotation. In effect, the endodontic instrument 14 has threaded itself into the canal in a clockwise fashion, until it cannot advance further without exceeding its maximum safe torsional load. The endodontic instrument 14 then is quickly pulled from the root canal 33 (by the handpiece 1, not by the dental professional) thus removing a thin layer of dentin until the handpiece 1 senses that the endodontic instrument 14 is back to a zero torsion load level. During this withdrawal process if the tension level reaches its maximum, the endodontic instrument 14 simply unthreads itself to stay within a safe level of tension. This same process repeats itself very quickly and automatically until the handpiece 1 senses that the desired depth of cut has been reached (i.e., Working Length during apical instrumentation). During this process if the physical limitation of the endodontic instrument 14 will not allow the Cutting Objective to be reached safely, an alternative approach is suggested which in most cases will be dropping down to the next smaller size endodontic instrument 14.

Many different motions will be programmed such that many different situations encountered can be quickly and safely instrumented. For example, endodontic instrument 14 may ledge root canal 33 when the rigidity of the endodontic instrument 14 overcomes the ability of the root canal 33 to keep the endodontic instrument 14 centered within the original confines of the root canal 33. Advancement (feed rate), rotational speed of the instrument (rpm), flexibility, instrument tip type and canal anatomy all factor into whether or not the instrument will cause a ledge. The current invention greatly reduces the chances of ledging by removing human error by adjusting the feed rate, rotational speed and imparting a unique motion when the handpiece 1 senses a curve and allowing the endodontic instrument 14 to follow nearly any canal curvature quite precisely. In the case of an “impossible curve” the tip of a small file will be taken past the curve and the handpiece 1 will impart a very rapid push-pull “filing motion” to smooth out the curve and intentionally transport the root canal 33 so that larger instruments can pass through to the Working Length.

When using hand instruments, experienced dental professionals know when to use which motion and how much pressure to apply in a given situation. This system 17 will simulate what an expert dental professional would do in any given situation, only it will do so very rapidly and without operator fatigue. Partial turn—pull will be the preferred motion to take advantage of the instrument's strength in tension but all motions will be available.

In summary, this system 17 optimizes canal instrumentation efficacy by accurately enlarging the canal to the correct Working Length and Working Width. It eliminates fatigue, optimizes efficiency and speed while eliminating the chance of instrument separation caused by human error.

Additionally, a unique means for attachment 3 to the handpiece 1 will be utilized so that not just any endodontic instrument 14 can be used. In one embodiment, the means for attachment 3 will contain scanner 6 to scan the information coding 54 on the endodontic instrument 14 to identify the endodontic instrument 14 to the computer 3. Data for each endodontic instrument 14 will be read and stored for later use on the computer 3. For example, data will be maintained for the purposes of controlling the number of uses so that the endodontic instrument 14 can be discarded at the appropriate time—avoiding separation from fatigue. Examples of information coding 54 includes the use of authentication chips, 2 and 3D barcoding, optical recognition or any other means of identifying unique items known to those skilled in the art.

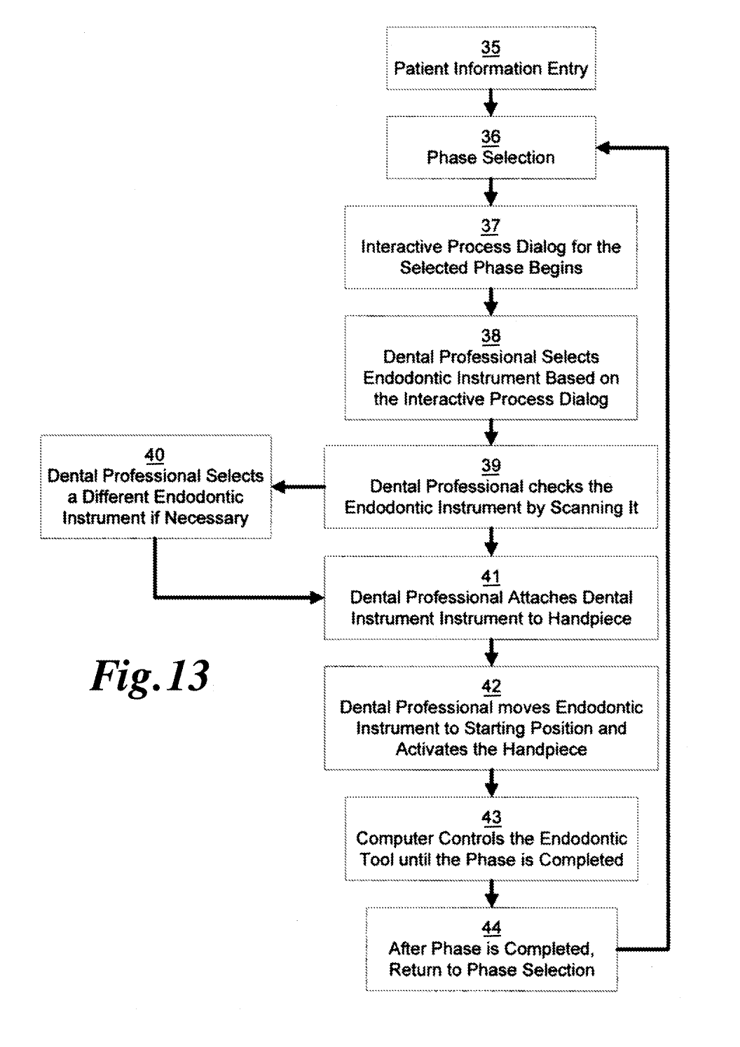

An exemplary embodiment of this invention might better be illustrated by a detailed example of how the system 17 would perform in an endodontic procedure. FIG. 13 shows a flowchart of how such a procedure would work.

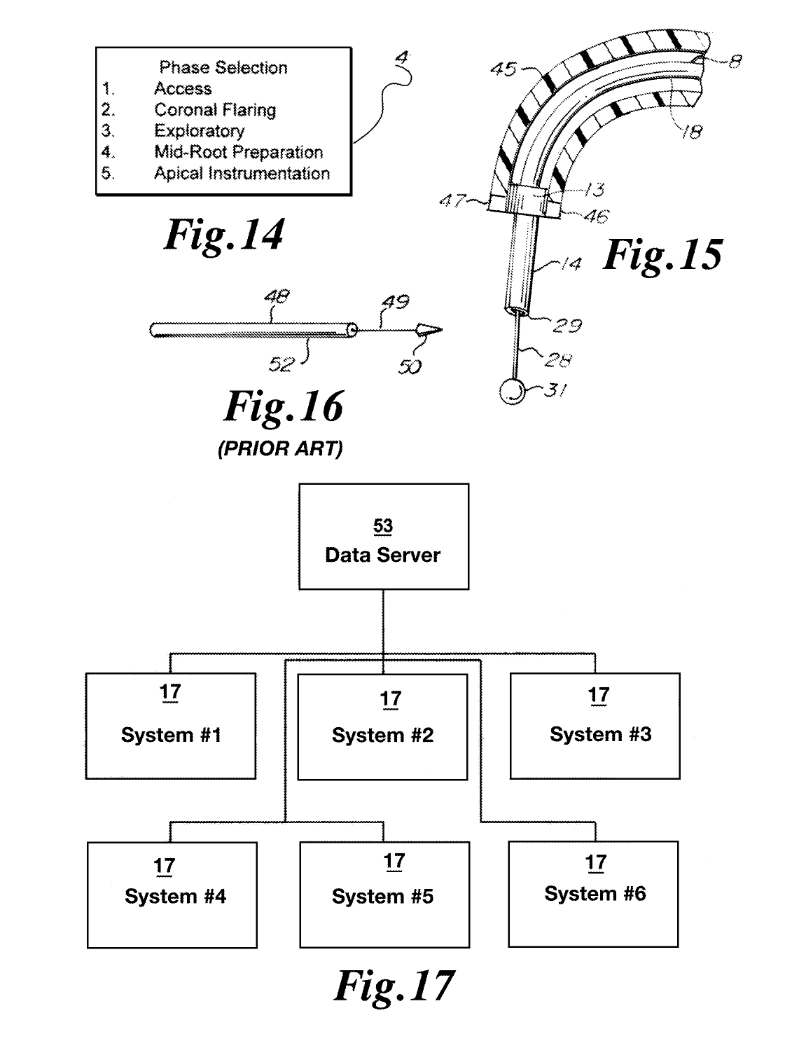

At 35 of FIG. 13, basic information about the case will be entered into the computer 3 through chair-side monitor 4 and the input system 5 when the patient arrives. Once the basic information is entered, the computer 3 prompts the dentist to select one of a plurality of pre-programmed phases which is represented by 36 of FIG. 13. FIG. 14 is an example of what the chair-side monitor 4 might display at the phase selection screen. In this example embodiment, there are six pre-programmed phases which are done in succession to form a complete endodontic procedure would be Access, Coronal Flaring, Exploratory, Mid-Root Preparation, and Apical Instrumentation.

After selecting a phase, the Interactive Process Dialog starts at 37. Each pre-programmed phase has its own unique Interactive Process Dialog which walks the dental professional through the procedure step-by-step. For example, at the beginning of the Access Phase the chair-side monitor 4 might display the proper access outline form superimposed over a representation of the top of the selected tooth. The usual locations of the canal orifices, the number of canals typically found along with a step-by-step technique for achieving Straight-Line Access.

Each pre-programmed phase would have its own endodontic instrument 14 associated with it. For the purposes of this example embodiment, there would be five endodontic instruments 14 capable of being connected to the handpiece, one for each of the following pre-programmed phases: Access, Coronal, Exploratory, Mid-Root and Apical. Each endodontic instrument 14 is designed to accomplish its unique Cutting Objective as efficiently and safely as possible taking into consideration the purpose of the instrument, design consideration and motion that the endodontic instrument 14 will be performing in the execution of the phase that it is designed for. Continuing with the current example embodiment, there would be five different instrument types, one for each of the five phases, Access, Coronal Flaring, Exploratory, Mid-Root Preparation and Apical Instrumentation.

The following provides a brief description of the key differences between the various endodontic instrument 14s that are used in the different phases.

Coronal Flaring Phase Instrument

Purpose: Its purpose is to rapidly create a funnel form in the coronal third to make it easier for subsequent instruments to enter the root canal 33. It also cleans the coronal third of the root canal 33.

Design Considerations: Flaring instruments are best suited with non-cutting tips. They should have large tapers between 10 and 20%. To prevent ledging, its tip must be flexible so that it does not create its own path or create a ledge so that other instruments cannot traverse the entire canal. Instruments of this type are typically large, beginning with ISO tips sizes #50 and higher. Since removal of a large amount of dentin is required, stainless steel may be the preferred material however; any biocompatible material that can be manufactured with screw-like blades could be suitable. The material must be able to withstand high forces in torsion and tension. The large size of these instruments however should be easily capable of handling both tensile and torsional stresses but they will be monitored nonetheless. Cutting length should be approximately 4 mm with a shaft of about 10 mm to clear the crown and reach the canal orifice. Flute depth is deep because these instruments are intended to cut large amounts of dentin quickly and efficiently. Helical angle can be straight or very shallow to minimize self threading. Its handle must be capable of turning the blades clockwise (forward) and counterclockwise (backwards) as well as pull/push.

Motion: These instruments will normally be run at a high rpm and high feed rate. They will take large amounts of dentin quickly then back out of the canal quickly. This motion is repeated until the instrument reaches its Cutting Objective, approximately 4 mm into the orifice. If the forces become too great, the motion will be adjusted accordingly.

Technique: The dental professional decides which of 4 instrument sizes is best for the particular root canal 33. The chosen instrument is scanned then placed in the handpiece 1 which is moved to the starting position. Pressing the push button 9 to activate the handpiece 1 begins the process and the endodontic instrument 14 advances without rotation until it can go no further. Instrument backs off 1 mm and clockwise rotation is started at a predetermined rpm and begins advancing down the root canal 33. The computer 3 monitors the endodontic instrument's 14 forces like torque, tension, compression being careful not to exceed its breaking point. The endodontic instrument's 14 motion (clockwise rotation, advancement, stop, pull) is rapidly repeated until reaching a depth calculated as 4 mm past the orifice. If the endodontic instrument 14 is not able to reach such depth safely the instrument's motion will stop and the dental professional is prompted to replace the current endodontic instrument 14 with a smaller size endodontic instrument 14 and try again.

Exploratory Phase Instrument

Purpose: Its purpose is to locate the proper path of the root canal 33 from orifice to foramen. At this Phase it is not necessary to completely clean the root canal 33, just start down the root canal 33 and stay on the proper path to allow subsequent instruments to follow the proper path.

Design Considerations: The Exploratory instrument is best suited with a cutting or semi-cutting self-threading tip. It must take hold of the debris or a very thin layer of dentin and work itself down the canal. It must burrow its way through the soft tissue or push aside the debris that may reside in the canal at the start of the procedure. To prevent ledging it must be very flexible so that it stays in the canal and does not create its own path. Endodontic instruments 14 of this type are typically small with ISO tips sizes of #6, #8, #10, #15. There must be a balance between flexibility and rigidity because if they are too flexible they will not go down the root canal 33. These will be subjected to increased tensile and compressive forces so a material able to withstand such forces is critical. Therefore stainless steel might be the preferred material however; any biocompatible material that can be manufactured and is harder than dentin may be suitable. To provide added rigidity, these instruments could be made with a slight taper, 1, 2 or 3%. Cutting length should be between 16 and 25 mm with another 10mm for the crown. Flute depth is very shallow because these endodontic instruments 14 are not intended to cut significant amounts of dentin. Helical angle is very steep so that is can thread and burrow itself down the canal if necessary. Its handle must be capable of turning clockwise (forward) and counterclockwise (backwards), pushed and pulled without pulling loose from the shaft. A one-piece design should be considered.

Motion: Exploratory instruments will be used primarily in a rapid filing motion (push/pull). Some reciprocation will be needed as well to help clear the blades of debris. Their objective is to simply create a path for subsequent instruments to travel. They will push the debris to the side for removal by subsequent instruments later in the process. They essentially create a path of least resistance for subsequent instruments that come later.

Technique: The smallest endodontic instrument 14 is placed in the handpiece 1 which is then located at the starting point by the dental professional. In the starting position the tip of the endodontic instrument 14 is below the orifice of the canal being instrumented. Forward advancement (no rotation) begins the motion sequence; once encountering resistance to forward advancement the motion begins as a rapid push-pull motion, forward advancement, twist clockwise/counterclockwise. The computer 3 monitors the tensile and torque levels of the endodontic instrument 14 being careful not to exceed its breaking point. Advancement continues in this same manner until reaching near the apex (preferably slightly past the foramen) based on an estimated Working Length programmed into the computer 3 by the dental professional. Once reaching approximate Working Length, motion stops and the dental professional is prompted to attach the foramen locator to the file. Through the handpiece 1 the endodontic instrument 14 is rotated, slowly, clockwise/counterclockwise while the dental professional reads the locator and sets the actual Working Length by pressing the Start Button. The dental professional is prompted to take a radiograph to confirm length. Once confirmed the actual Working Length is set by the so that subsequent apical instruments can be taken to precisely this same length later in the process. If unable to reach the desired depth safely in this manner, the dental professional will be prompted to repeat. Should this fail the dental professional has the option to take the greatest length achieved or to complete the process with k-file in hand and enter the actual Working Length into the computer 3 manually.

Mid-Root Flaring Phase Instrument

Purpose: The third type instrument is designed to taper the root canal 33 according to the wishes of the dental professional based the preferred obturation technique. Multiple tapers will be offered to suit many different obturation methods.

Design Considerations: Mid-root instruments are best suited with a self-threading but non-cutting tip. It should have multiple tapers, typically from 1 to 12%. It must be flexible so that it does not create its own path or create a ledge so that other instruments cannot traverse the entire canal. Endodontic instruments 14 of this type should be made with small tips sizes from #15 to #25 as cutting at the tip is not desired. There must be a balance between flexibility and rigidity because if they are too flexible they will not go down the canal. Nickel-titanium might be the preferred material; however, any biocompatible material that can be manufactured with screw-like blades and is harder than dentin could be suitable. The material must be able to withstand moderate forces in torsion as it will literally be “screwed into” the canal then pulled, so tensile forces are also high. Care must be taken to keeping wedging forces to a minimum. Cutting length should be between 5 and 10 mm with another 8 to 10 mm for the crown length. Flute depth is deep because these endodontic instruments 14 are intended to cut large amounts of dentin quickly and efficiently. Helical angle can be moderately steep. Its handle must be capable of turning clockwise (forward) and counterclockwise (backwards) as well as withstand significant pulling and pushing forces.

Motion: These endodontic instruments 14 will be “screwed into the canal” and then pulled out until there is no torsion force remaining on the instrument. If the tensile force while pulling becomes too great, the handpiece will “unscrewed” the instrument out of the root canal 33 rather than risk pulling it apart. This motion repeats rapidly until the tip of the endodontic instrument 14 reaches the Working Length.

Technique: Based on the desired taper, the dental professional chooses the endodontic instrument 14 taper most likely to be the final taper desired. The chosen endodontic instrument 15 is placed in the handpiece 1 and the handpiece 1 is set at the starting position. The computer 3 takes control and the instrument is advanced without rotation into the root canal 33 until it meets resistance. Forward advancement and clockwise rotation is started while the computer monitors the torque level of the instrument being careful not to exceed its breaking point. The depth of travel and tensile load will be monitored continuously. This forward advancement/clockwise rotation/pull motion repeats rapidly until reaching the proper cutting depth in the apical third. If the endodontic instrument 14 is able to reach the desired depth the computer 3 will tell the dental professional the process is complete. If the endodontic instrument 14 is not able to reach such depth, the dental professional will be prompted to repeat the same process with the next smaller endodontic instrument 14, and then repeat again with the final desired tapered endodontic instrument 14.

Apical Instrumentation Phase Instruments

Purpose: The fourth type of instruments is designed to properly prepare the root canal 33 to the proper Working Width at the proper Working Length. Trial and error will be used to determine the appropriate level of torque and resistance to advancement over a certain length of cut to closely approximate when the apical canal is properly prepared. The computer 3 will store typical Working Length and Working Widths based on historical anatomical records and use an algorithm to calculate Working Width and prompt the dental professional when Apical Instrumentation is complete. Since these endodontic instruments 14 will be taken to Working Length the depth will be continuously monitored and the endodontic instrument 14 will not be allowed to go past that depth unless overridden by the dental professional.

Design Considerations: Apical instruments are best suited with a self-threading semi-cutting tip. It should have a zero or reverse taper so that the torque will be felt near the tip of the instrument. Blade length is short, not more than 5 mm. To prevent ledging its tip must be flexible so that it does not create its own path or create a ledge so that other instruments cannot traverse the entire canal. Instruments of this type must be offered in a wide range of sizes, from 0.20 mm to 1.60 mm and higher. Nickel-titanium might be the prefer material however, any biocompatible material that is harder than dentin could be suitable. The material must be able to withstand high forces in torsion as well as resist breaking from fatigue. Flute depth is shallow because these instruments are intended to cut just a small amount of dentin quickly and efficiently. Helical angle can be very steep, possibly even zero. Its handle must be capable of turning clockwise (forward) and counterclockwise (backwards) as well as pulling forces.

Motion: Among the many potential motions, one such motion could be that these instruments will be slowly “screwed into the canal” and then pulled out until there is no torsion force remaining on the instrument. If the tensile forces become too great, the handpiece will “unscrewed” the instrument out of the canal rather than risk pulling it apart. This motion repeats rapidly until the tip of the instrument reaches the actual Working Length set earlier with the Exploratory instrument.

Technique: Based on a chart of known Final Apical Sizes, the dental professional, prompted to choose the instrument size most likely to be the Final Apical Size. The chosen instrument is placed in the handpiece and set to the correct starting position. Once in place the dental professional presses the push button 9 to activate handpiece 1 and the endodontic instrument 14 advances into the root canal 33 (not rotating yet) until it can go no further. Since ½ of the root canal 33 length has already been prepared, the instrument will go deep into the root canal 33 before resistance is met. Forward advancement and clockwise rotation is started by the handpiece 1 while the sensors and load cells 22 monitor the torque level of the endodontic instrument 14 being careful not to exceed its breaking point. This motion repeats rapidly until the endodontic instrument 14 reaches a preprogrammed torque when it reverses rotation and pulls quickly to scrape away a thin layer of the root canal 33 wall. This repeats rapidly until the tip reaches Working Length. If the endodontic instrument 14 is able to reach WL the computer 3 will inform the dental professional if this endodontic instrument 14 is the correct Final Apical Size based on an algorithm stored in the computer 3. If not, the process will be repeated with the next larger size endodontic instrument 14. If the endodontic instrument 14 is not able to reach such depth because the torque level is exceeded, the handpiece 1 will stop and the dental professional is prompted to replace the current endodontic instrument 14 with the next smaller size endodontic instrument 14 and try again. This process will repeat with smaller/larger endodontic instruments 14 until the computer 3 informs the dental professional that the correct Final Apical Size has been reached. Since the most common FAS is chosen to begin with, it is likely that only a few endodontic instruments 14 will be required to prepare to the correct apical size.

Depending upon the phase of the procedure, the Computer prompts the dental professional to choose the appropriate instrument at 39 and the selection is double-checked when the endodontic instrument 14 is identified by the dental professional by using the scanner 6. After the computer 3 recognizes the instrument, it is able to retrieve data about that specific endodontic instrument 14 such as: remaining useful life, # of cycles to failure, maximum torque to failure, bending moment (flexibility), maximum tension to failure, maximum and minimum speed range. If the endodontic instrument 14 is not within the computer 3 calculated lifetime, the computer 3 will prompt the dental professional to replace the endodontic instrument 14 at 40. If the endodontic instrument 14 is within the computer 3 calculated lifetime, the dental professional connects the endodontic instrument 14 to the handpiece 1 at 41 by using the attachment mechanism 13.

The dentist is prompted to move the handpiece 1 into the proper starting position. FIG. 18 shows the handpiece 1 in the proper starting position, normally resting the head of the handpiece on a specific cusp or other suitable purchase point chosen by the dental professional. The computer 3 stores this starting position, and prompts the dental professional to activate the handpiece 1 when they are ready to begin at 42. From that point the computer 3 takes control, running the preprogrammed program for that endodontic instrument 14 until the phase has been completed at 43.

As the process progresses, the forces on the endodontic instrument 14 are continuously monitored and the endodontic instruments 14 preprogrammed motion is altered if values from the 22 sensor and load cells indicate safety limits of the endodontic instrument 14's physical properties are reached. Otherwise, if the parameters stay within the safety limits, the pre-programmed cutting motion continues uninterrupted. If the endodontic instrument 14's design limitations are exceeded before reaching the completion of the phase, the computer 3 will modify the cutting motion and rotational speed. If the computer 3 cannot overcome the situation, it will prompt the dental professional and recommend an alternative instrumentation approach such as dropping down to the next smaller size endodontic instrument 14.

For example, during the Apical Instrumentation Phase if the estimated Final Apical Size for this particular root canal 33 is most commonly a size #55, the computer 3 will recommend that the dentist start apical instrumentation with the #55. However, if the #55 cannot reach Working Length safely, the computer 3 would recommend dropping down a size to the #50 before trying the #55 again (assuming the #50 is not the actual FAS).

The quality of the preparation is also assured because the computer 3 controls both the cutting depth (Working Length) and diameter (Working Width). Working Length is first estimated by the computer 3 based on anatomical data stored but can be overridden by the dental professional based on the pre-op x-ray. Then the actual Working Length is later determined by a foramen locator connected to the Exploratory instrument and stored in the computer 3 so that apical instruments are taken precisely to this same depth, no less, no more. The correct Working Width is calculated by the computer 3 based on an algorithm (similar to the technique used by electronic foramen locators) and will inform the dental professional when the apical canal has been made round, indicating canal instrumentation is complete. The computer 3 will store all this information and the staff will be able to use the printer 7 to obtain a printout of key clinical information to include with the patient's record.

Once one phase in the overall procedure has been completed, the dental professional will select the next phase in the sequence at 44. For example, if the dental professional has completed the coronal flaring phase, the next phase will be the exploratory phase. In this phase, the program will begin by asking the dental professional to select which root canal 33 they wish to begin instrumentation from a list of root canal 33 names (based on tooth #) and in which sequence (assuming there is more than one root canal 33). Then, the chair side monitor 4 will display a suggested Working Lengths for that particular root canal 33 based on anatomical studies but will prompt the dental professional to override this default, if necessary, based on the pre-op x-ray, their clinical experience. Once this data is entered, it instructs the dental professional to select an endodontic instrument 14 and scan it with scanner 6 and the Computer will record the instrument's unique information coding 54. In the preferred embodiment, the scanner 6 will be integrated into the handpiece 1 so that there in no mistaking which endodontic instrument 14 is in the handpiece 1 while in use. The dialog will prompt the dental professional to move the endodontic instrument 14 to the starting position. When ready, the dental professional will press the push button 9 to start the endodontic instrument 14 motion sequence. The motion of the endodontic instrument 14 will follow the preprogrammed Cutting Objective for the Exploratory Phase. The motion and procedural steps of endodontic instrument 14 will change dynamically depending on the situation. If unusual circumstances are encountered, the dental professional will be prompted to take alternative action.

Assuming an uneventful operation, when the estimated Working Length has been reached with the endodontic instrument 14, the dental professional will be prompted to use an Electronic Foramen Locator. The dental professional, through the handpiece 1, will be able to very slowly advance and withdraw the endodontic instrument 14 until reading the exact position they wish to consider as their actual Working Length. By pressing the Start Button the exact position of the endodontic instrument 14 is recorded for use in the subsequent Apical Instrumentation Phase.

The process will be repeated for each phase of the overall procedure. However, each phase will have its own Unique Interactive Process Dialogs preprogrammed.

The aforementioned was merely an example of how this system 17 can be used in a 5 step endodontic procedure. However, in recognition that each endodontic procedure represent a different set of variables because of different teeth, the system 17 is flexible such that it can perform any number of variations of endodontic procedure provided that sufficient endodontic instruments 14 are provided as well as pre-programmed phases are programmed into the computer 3.

In another embodiment of the computer 3, it can connect to a network or the internet in order to update the preprogrammed phases, add new phases for different types of endodontic procedures, modify existing preprogrammed phases and provide any type of software or firmware update.

In yet another embodiment, a kit can be made available containing a series of endodontic instruments 14 and guide wires 27 to be used in a procedure. Such a kit would contain a set of the various endodontic instruments 14 for the different phases. The kit may include, or be available in a separate kit, a series of different sizes for the guide wires 27.

FIG. 17 shows yet another embodiment where a plurality of systems 17 can be connected to a central data server 53 through a computer network. In this embodiment, the systems 17 are able to upload or otherwise transmit the data to the data server 53. The means of data transmission can be through any number of standard data transmission protocols, such as, wireless internet, Ethernet cables or Bluetooth. The advantage of having all the data stored on a central server is that all of the systems 17 connected to the network will have access to the same information. That would permit different endodontic instruments 14 to be used with different computers 3. Also, it would allow for easier equipment replacement, in particular, if the computer 3 needs to be replaced. Yet another benefit would be that all the systems 17 in an office can be updated at the same time with new information.

While preferred embodiments of the invention have been described and illustrated above, it should be understood that these are exemplary of the invention and are not to be considered as limiting. Accordingly the invention is not considered to be limiting by the foregoing description, but only limiting by the scope of the claims.

1. A dental handpiece comprising:
an external housing with a distal end and a proximal end;
said distal end further comprises an attachment mechanism for removably connecting a dental instrument;
said dental instrument is coupled to at least one motor which exerts a mechanical force on said dental instrument;
at least one camera mounted at said distal end of said external housing, said camera is in electronic communication with at least one microprocessor; and
said at least one microprocessor is in electronic communication with said at least one motor;
wherein said at least one camera transmits data to said microprocessor which displays an image from said camera on a display and said microprocessor controls said at least one motor.

2. The dental handpiece of claim 1 wherein said at least one motor is located within said external housing.

3. The dental handpiece of claim 1 where said at least one motor is located outside of said external housing.

4. The dental handpiece of claim 3 further comprising a hollow bore located within said external housing extending along the longitudinal axis of said external housing from said attachment mechanism to said proximal end.

5. The dental handpiece of claim 4 further comprising a drive cable located within said hollow bore extending from said attachment mechanism to said at least one motor.

6. The dental handpiece of claim 5 wherein said drive cable further comprises a data transmission cable.

7. The dental handpiece of claim 5 wherein said drive cable further comprises a power cable.

8. The dental handpiece of claim 1 wherein said electronic communication is a wired connection.

9. The dental handpiece of claim 1 where said electronic communication is a wireless connection.

10. The dental handpiece of claim 1 further comprising at least one sensor in electronic communication with said at least one microprocessor.

11. The dental handpiece of claim 1 wherein said mechanical force exerted by said at least one motor on said dental instrument causes said dental instrument to move laterally along its longitudinal axis.

12. The dental handpiece of claim 1 wherein said mechanical force exerted by said at least one motor on said dental instrument causes said dental instrument to move laterally along its longitudinal axis.

13. The dental handpiece of claim 1 further comprising at least one camera motor coupled to said camera and in electronic communication with said at least one microprocessor; wherein said microprocessor controls said at least one camera motor to control positioning and focus of said camera.

14. The dental handpiece of claim 1 further comprising a battery.

15. The dental handpiece of claim 1 wherein said dental instrument further comprises a means for information coding for electronically identifying said dental instruments's design.

16. The dental handpiece of claim 15 wherein said dental instrument further comprises a means for identifying said dental instrument based on said means for information coding.

17. A method of using a dental handpiece comprising the steps of:
selecting a pre-programmed dental procedure from menu on a computer;
said computer retrieves dental procedure information and displays dental procedure information for said on a display coupled to said computer;
positioning a handpiece in accordance with said pre-programmed dental procedure on said display; and
activating said handpiece;
wherein said handpiece comprises at least a camera and at least one sensor in electronic communcation with said computer and said at least one camera and sensor transmits real-time procedure data to said computer; and
said computer monitors progression of said pre-programmed dental procedure based on real-time procedure data received from said at least one camera and sensor and user input.

18. The method of claim 17 further comprising the step of selecting an electronically coded dental instrument, coupling said electronically coded dental instrument to said dental handpiece and said dental handpiece identifying said electronically coded dental instrument.
